(19) United States
(12) Patent Application Publication
(10) Pub. No.: US 2004/0003067 A1
(43) Pub. Date: Jan. 1, 2004

(54) System and method for enabling a user interface with GUI meta data

(76) Inventor: Daniel Ferrin, Colorado Springs, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/183,004

(22) Filed: Jun. 27, 2002

(51) Int. Cl. G06F 15/173; G09G 5/00

(52) U.S. Cl. 709/223; 709/238; 345/735

(57) ABSTRACT

A system and method for graphically representing and managing network and network device information is described. In one embodiment, the described method generates a graphical display representing at least a partial configuration of a network device. This method includes the steps of receiving an indication of a configuration category; retrieving a stylesheet corresponding to the network device and to the configuration category; retrieving instance data corresponding to the network device; identifying renderable objects using the retrieved stylesheet and the retrieved instance data; retrieving a browser theme; providing the renderable objects to the browser theme; and rendering the renderable objects using the browser theme.

### FIELD OF THE INVENTION

The present invention relates to network device management. In particular, but not by way of limitation, the present invention relates to systems and methods for graphically representing and managing network and network device information.

### BACKGROUND OF THE INVENTION

Networks, and in particular, the Internet, have revolutionized communications. Data vital to the continued prosperity of the world economy is constantly being exchanged between end-users over these networks. Unfortunately, the expansion and maintenance of present networks is outpaced by the demand for additional bandwidth. Network equipment is often difficult to configure, and qualified network engineers are in extremely short supply. Thus, many needed network expansions and upgrades must be delayed until these engineers are available. While these upgrades and expansions are pending, end-users continue to suffer poor network performance.

Cisco™ routers, for example, are notoriously difficult to configure—especially in light of the new XML-based interfaces introduced by competitors such as Juniper Networks™. Instead of a user-friendly XML-based interface, Cisco uses a cumbersome command line interface (CLI) for its routers. Cisco's CLI is the result of many years of semi-controlled modifications to its router operating systems and has resulted in a tangled mess of commands and subcommands. This cumbersome interface is one reason that Cisco requires that Cisco-certified engineers work on its routers.

Cisco could reduce the complexity of its routers and reduce the need for Cisco-certified engineers by producing a user-friendly interface. If Cisco attempted to abandon its CLI in favor of such a user-friendly interface, however, many years of development and expertise could be lost. Moreover, even if it could develop a user-friendly interface, there is presently no economical way to integrate it into the thousands of existing Cisco routers.

Despite the difficulties in implementing a more user-friendly interface, to remain competitive, Cisco and similarly situated companies need to move away from their present interfaces. Present technology, however, does not provide these companies with an acceptable option that allows continued use of their extensive interface knowledge base, whether it be CLI or some other type of interface, while simultaneously providing system administrators and network engineers with a user-friendly interface. Moreover, present technologies do not provide an acceptable way to provide backward compatibility of new user-friendly interfaces with existing network devices.

Cisco, of course, is not the only network device manufacturer to face this interface-upgrade problem. Many manufacturers would like to continue using their existing interface knowledge base while providing system administrators a user-friendly interface that is consistent across multiple platforms. Accordingly, a system and method are needed that will allow manufacturers, like Cisco™, to create user-friendly interfaces for both next-generation and existing devices.

### SUMMARY OF THE INVENTION

Exemplary embodiments of the present invention that are shown in the drawings are summarized below. These and other embodiments are more filly described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In commonly owned and assigned application no., Attorney Docket No. CNTW-008, entitled System and Method for Modeling a Network Device's Configuration, a system and method for modeling a network device's configuration is described. Briefly, application no. CNTW-008 discloses, in one embodiment, a device and method for generating a device-neutral set of configuration commands from device-specific configuration commands. This process is generally conducted by using a schema, which includes a set of structurally organized configuration commands available to a particular class of network device. For example, the CNTW-008 application discloses a system and method for converting a set of available CLI configuration commands into an XML document or into a DOM representation of those configuration commands.

The present invention, in one embodiment, can provide a complimentary system and method to that disclosed in the CNTW-008 application—although the present invention can also operate independently of the system and method disclosed in CNTW-008. The present invention, for example, can include a system and method for generating a graphical user interface (GUI) that can display a network device's configuration in a device-neutral format. In another embodiment, the present invention can include a system and method for integrating edited configuration commands into a structured document that represents the configuration of the network device.

In one embodiment, the present invention can include a graphical generator, a post processor, a stylesheet data device, a network device data device, and browser theme data device. In operation, a user could select a router, or any other network device, for configuration and then select a set of configuration commands, which are referred to herein as a configuration category. A configuration category can represent a logical grouping of configuration commands. For example, one configuration category could include all routing algorithm commands.

After receiving an indication of the selected router and configuration-category, the graphical generator can retrieve a stylesheet corresponding to the manufacturer, model, and/or operating system (OS) version of the selected router. This stylesheet data includes information about what type of data and what data items should be rendered for this router and configuration category combination. For example, the stylesheet could indicate, assuming certain conditions are met, that attribute A should be rendered through a button and that the button should be labeled “X.” The stylesheet data, however, does not necessarily include instructions on how to actually render the graphics. That information is generally stored in a browser-theme document.

The stylesheet can also include a series of conditional, e.g., if-then, instructions to be executed against the actual configuration of a network device. The data for this actual configuration can be retrieved from an instance document, which generally includes the actual configuration for a particular network device and is stored in a device-neutral, structured format. In other embodiments, however, the instance document can be any type of data structure that indicates the configuration of a particular network device.

In one embodiment, the conditional instructions in the stylesheet are used to generate a script file such as an XSL script. As the script file is executed, each element in the instance document is evaluated against the conditional instructions, thereby determining how or even if to render the particular elements. For example, the conditional instructions in the stylesheet may indicate that a particular attribute should not be displayed if a certain element is not in the instance document. Alternatively, the conditional instructions may indicate that a particular attribute should be displayed only if certain other elements are included in the instance document.

Once the elements to be rendered have been identified, the graphical generator retrieves browser theme data that includes the actual instructions for rendering those elements. In other words, if the stylesheet indicates that a button should be rendered and that it should be labeled “X,” then the browser theme data actually includes the instructions for rendering the button with that label. Thus, the graphical generator generates the actual display using instructions in the browser theme and data from the instance document. Notably, the browser theme data can be customized for different browser types or even for individual users.

In another embodiment of the present invention, data can be moved from attribute-value pairs, such as is found in an HTML document, to a structured document such as an XML document. In particular, one embodiment of the present invention can enable data such as attribute-value pairs to be moved from a GUI's representation of a network device's configuration into an instance document corresponding to the network device. For example, a user can alter the instance data related to a particular network device by changing existing data or entering new data into the GUI even though the instance data may be stored in an XML format.

Notably, a set of attribute-value pairs used by the GUI can be extracted from, for example, the associated HTML document so that any modified or new attribute-value pairs can be identified. If an identified attribute-value pair is determined to be a new attribute-value pair, e.g., the attribute has no corresponding structure in the instance document, a structural element can be added to the instance document to reflect the new attribute-value pair. For example, when the instance document is an XML document, an additional element representing the new pair can be added to the appropriate place within the XML document. Once this structural element has been added to the instance document, the value associated therewith can also be added.

If the attribute of the identified attribute-value pair corresponds to existing structure within the instance document, then the changed value can be written to that structure in the instance document. Because any value written to the instance document should be written to the correct structural element within the instance document, in one embodiment, each structural element in the instance document is associated with a unique identifier. When data is read from or written to the instance document, this unique identifier helps to prevent error.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of a conventional network;

FIG. 2 is a block diagram of a conventional router;

FIG. 3 is a block diagram of one embodiment of a system in accordance with the present invention;

FIG. 4 is a block diagram of an alternate embodiment of the present invention;

FIG. 5 is a block diagram illustrating one system for constructing GUI metadata;

FIG. 6 is a flowchart illustrating a method for constructing GUI metadata;

FIG. 7 is a flowchart of one method for displaying network device data; and

FIG. 8 is a flowchart of one method for extracting attribute-value pairs from a GUI and inserting the corresponding data into a structured document.

### DETAILED DESCRIPTION

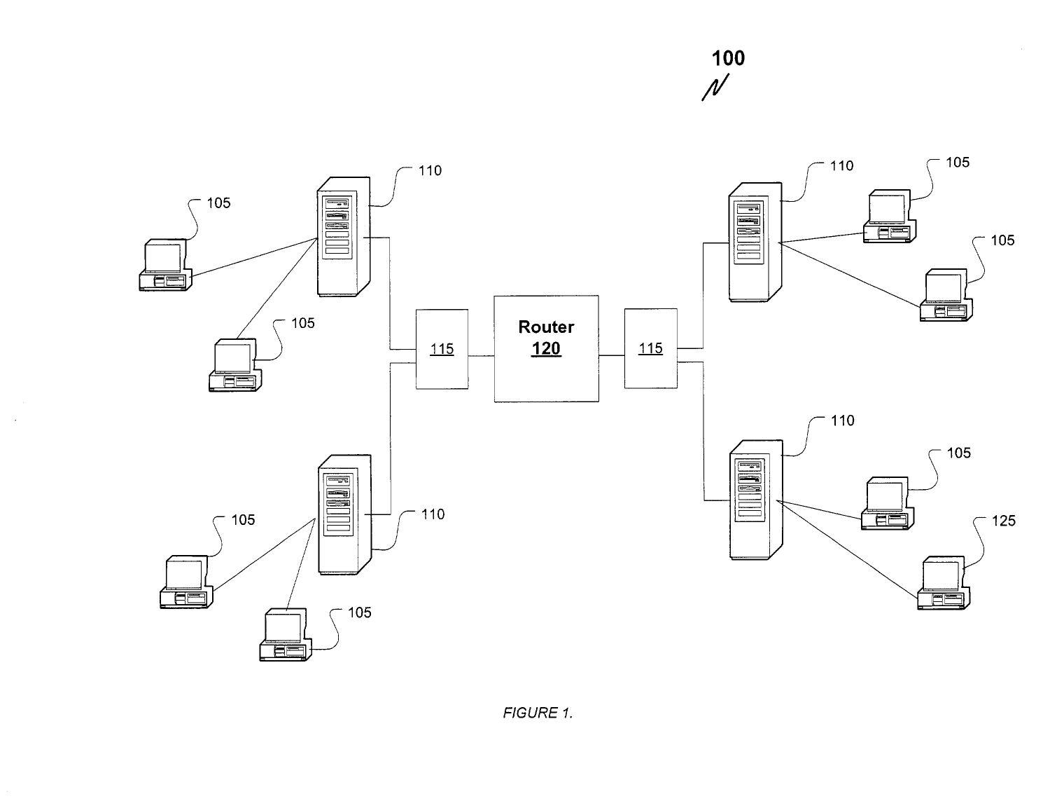

Referring now to the drawings, where like or similar elements are designated with identical reference numerals throughout the several views, and referring in particular to FIG. 1, it illustrates a block diagram of a conventional network system 100. In this network system 1 00, end-users 105 are connected to servers 11 0, which are connected to networking equipment such as hubs, not shown, optical components 115, and routers 120. Using the networking equipment, end-users 105 that are associated with different servers 110 can exchange data.

As new servers 110 and end-users 105 are added to the overall system 100, or as new software becomes available, the routers 120 and/or optical components 115 of the network system 100 may need reconfiguring. To reconfigure these components, a system administrator 125—with the proper authorization—could access the router 120 and/or optical component 115 by, for example, establishing a telnet connection to the component and transferring configuration instructions thereto.

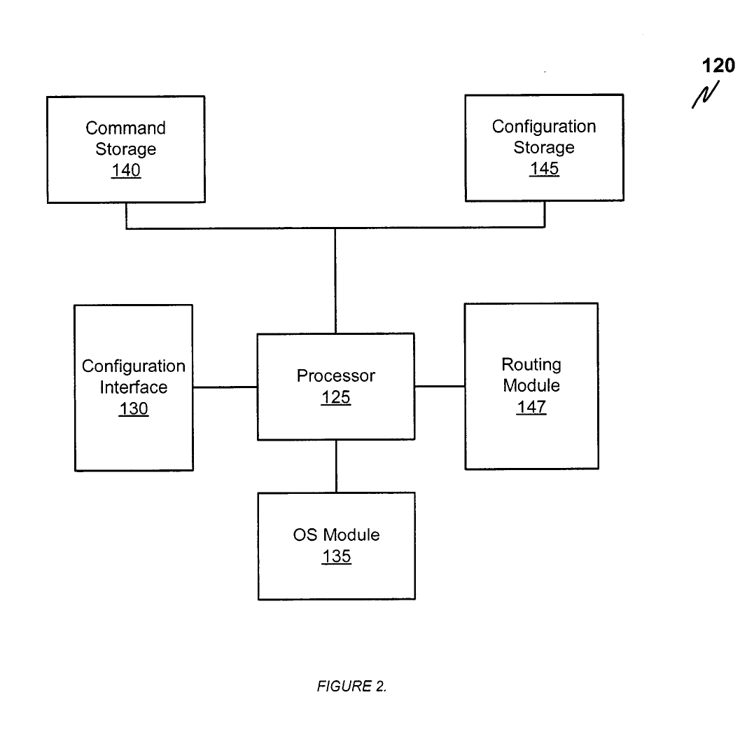

Referring now to FIG. 2, it is a block diagram of one type of conventional router. In this representation, a processor 125 is connected to a configuration interface 130, an operating system (OS) storage module 135, a command storage module 140, a configuration storage module 145, and a routing module 147. The illustrated arrangement of these components is logical and not meant to be an actual hardware diagram. Thus, the components can be combined or further separated in an actual implementation. Moreover, the construction of each individual component is well-known to those of skill in the art.

Still referring to FIG. 2, when a system administrator 125 wishes to reconfigure a router 120, he accesses the router 120 through the configuration interface 130 and retrieves the present configuration for the router 120 from the configuration storage module 145. If necessary, the system administrator 125 can review available configuration commands and associated bounds by accessing and reviewing the commands stored in the command storage module 140. In essence, the command storage module 140 provides the knowledge base for a “help” screen. The commands stored in the command storage module 140 are often unique to the particular OS version stored in the OS module 135.

After the system administrator 125 has assembled the new configuration instructions, these instructions are pushed through the configuration interface 130 and stored in the configuration storage module 145. As previously described, for Cisco routers, interaction is generally through a CLI. In other words, the command storage module 140 is queried through the CLI; available commands are returned through the CLI; and new configuration commands are provided to the router 120 through the CLI. Unfortunately, the CLI is difficult to manage and requires highly skilled engineers for even simple tasks.

For other routers, the configuration interface 130 could be, for example, XML based. Although the XML-based interface is easier to navigate than a CLI, each network device manufacturer that uses an XML-based interface generally structures its interface in a proprietary fashion. Thus, network engineers are still forced to learn many different interfaces and command structures even for XML-based network devices.

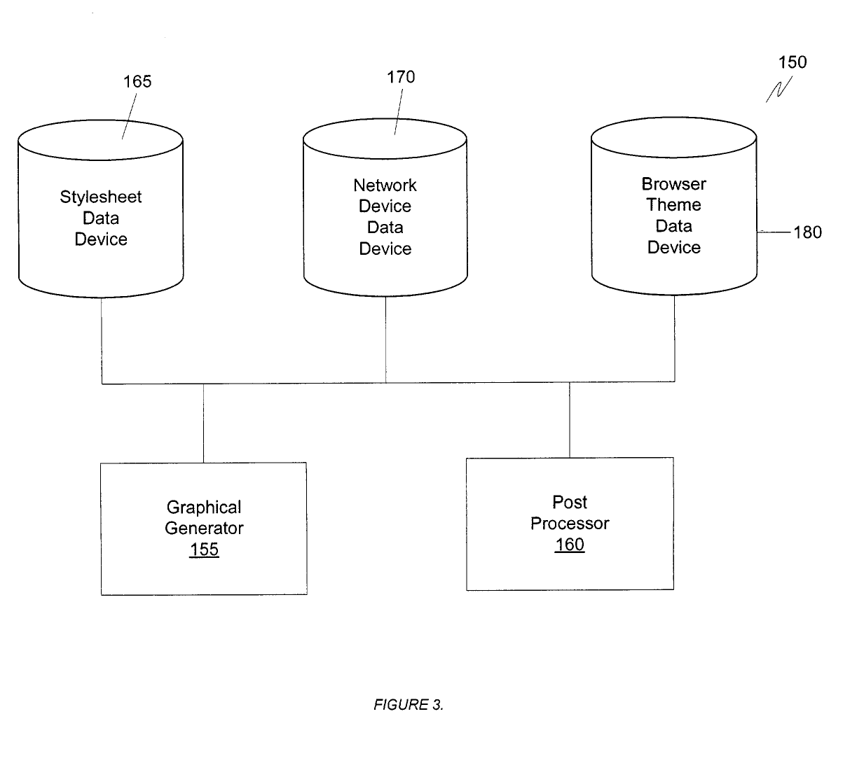

Referring now to FIG. 3, there is illustrated a block diagram of one embodiment 150 of the present invention. In this embodiment, a graphical generator 155 and a post processor 160 are in communication with a stylesheet data device 165, a network device data device 170, and a browser theme data device 180. Other embodiments can include combinations of these devices, for example, one embodiment includes only the graphical generator 155, the stylesheet data device 165, the network device data device 170, and the browser theme data device 180.

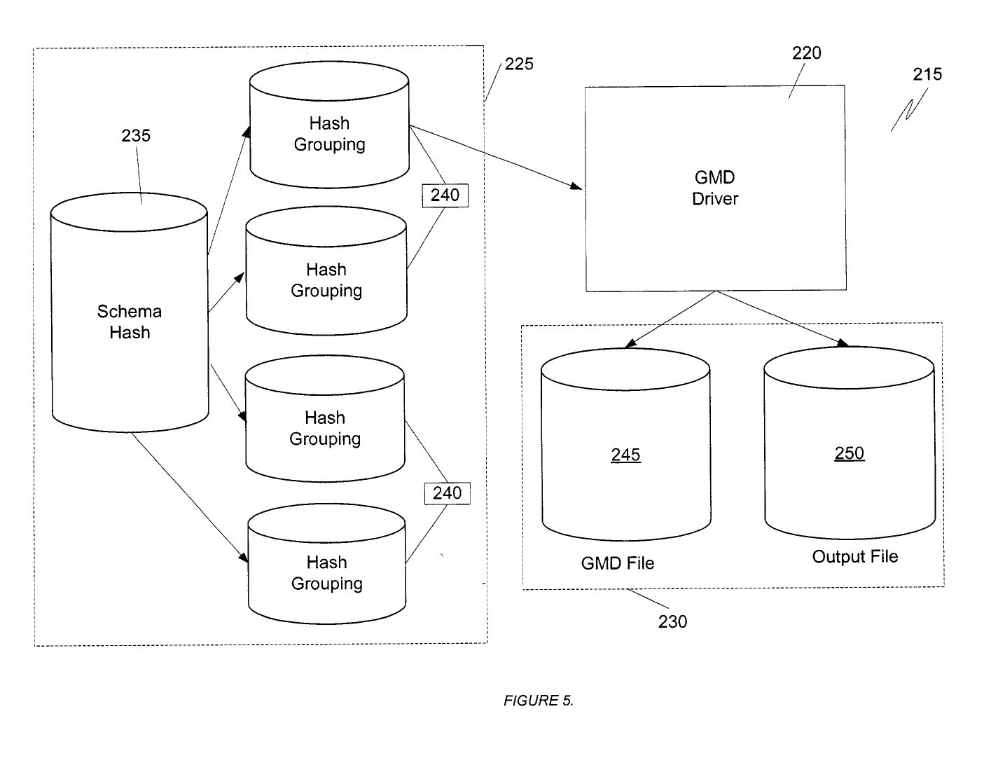

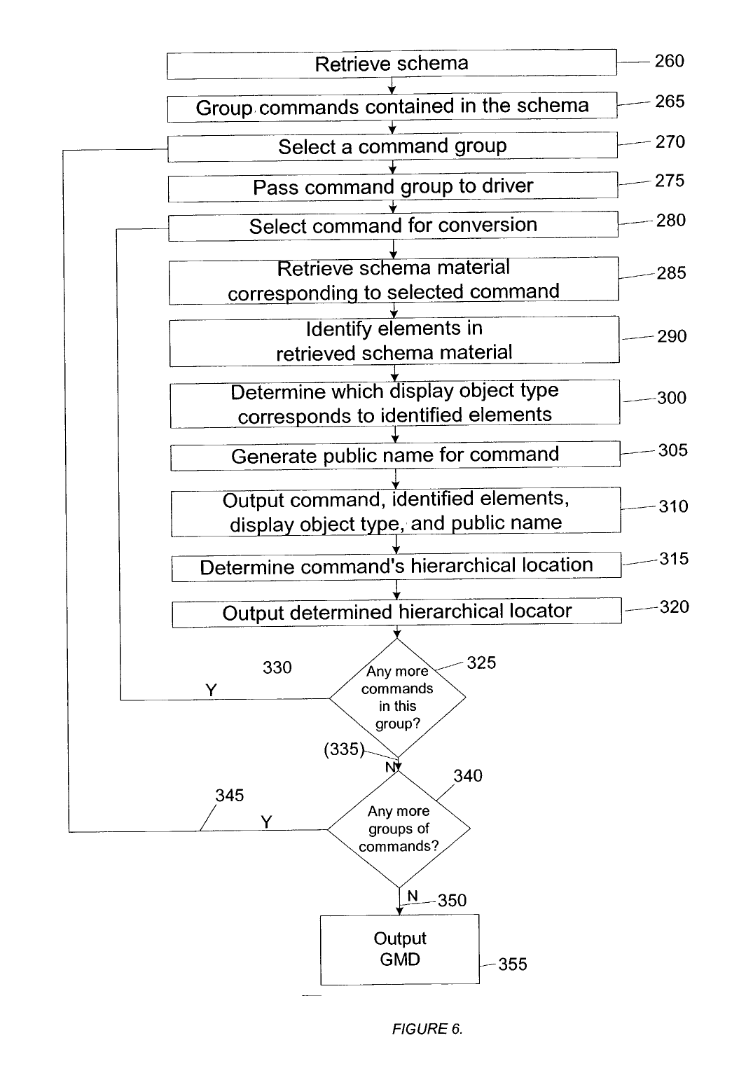

In operation, the graphical generator 155 uses stylesheet data, browser theme data and network device data-also called instance data—to render the GUI corresponding to a particular network device. For example, the graphical generator 155 can retrieve stylesheet data related to the type or class of network device corresponding to a selected network device. That is, the graphical generator can retrieve stylesheet data related, for example, to a Cisco model 7500 router running operating system (OS) version 1.0. This stylesheet data can be generated from GUI metadata (GMD), which is described in detail with regard to FIGS. 5 and 6. The stylesheet data can also be generated from schema data related to a particular type of network device. One implementation of this schema data is described in commonly owned and assigned patent application no. CNTW-007, entitled System and Method for Generating a Configuration Schema, which is incorporated herein by reference.

Briefly, however, the schema data comprises device-neutral representations of configuration commands available to classes of network devices. A separate schema can exist for each type, model and version of a network device. For example a Cisco model 7500 router running an operating system version 1.0 could be associated with a first schema, a Cisco model 7500 running an operating system version 2.0 could be associated with a second schema, and a Juniper M40 router could be associated with a third schema. In one embodiment, the schema is contained in a structured document such as an XML document. In other embodiments, the schema is contained in a hash arrangement that is described in commonly owned and assigned patent application no. CNTW-011, entitled System and Method for Generating an Intermediate Representation of Configuration Schema, which is incorporated herein by reference. In either embodiment, however, the structured arrangement of the configuration commands available to a class of network devices is retained.

Referring again to FIG. 3, the stylesheet data generally comprises instructions about configuration information that should be rendered and not the instructions on how to render it. In one embodiment, the stylesheet data is grouped according to logical categories based upon information that users would like to see grouped together. For example, one stylesheet could be related to routing algorithms, another to new service establishment, and another to quality of service. Thus, a particular stylesheet could be defined by router type, operating system, and configuration-category.

As previously described, the stylesheet data does not generally include information on how to actually render the GUI. Rather, the rendering information is generally included in the browser theme data. For example, if the stylesheet data indicates that category “routing algorithms” should include a drop down box with items “A-F,” the browser theme data would include the instructions on how and where to actually render that drop down box in the display. Because browsers are nonstandard, the browser themes may be customized for each type of browser. One browser theme would indicate how to render “routing algorithms” in, for example, Microsoft Explorer™ and another would indicate how to render it in Netscape Navigator™.

In operation, the graphical generator 155 can execute the stylesheet data for the selected device type against the instance document, which includes the configuration instance for a particular network device, for the selected device to determine which elements to render. In other words, the graphical generator 155 determines which of the elements included in the stylesheet data are relevant to the selected device and renders only those relevant elements. If the stylesheet, for example, includes information about a particular option that is not available to the selected network device, that option may not be rendered.

To identify which elements to render, the stylesheet can include a series of conditional instructions to be executed against the instance document for the selected network device. These instructions can be included, for example, in an XSL script that is generated from the stylesheet. As each element in the instance document is evaluated against the instructions from the stylesheet, the graphical generator 155 determines how or if to render that particular element. For example, the conditional instructions in the stylesheet may indicate that a particular attribute should not be displayed if a certain element is not in the instance document. Alternatively, the conditional instructions may indicate that a particular attribute should be displayed only if certain other elements are in the instance document. In yet another embodiment, the conditional instructions indicate where in the instance document that data changed by the user should be added.

To enable the conditional instructions to identify the correct elements in the instance document, unique identifiers can be added to elements within the instance document. These unique identifiers can be combined with the hierarchical location of the element to create a unique name for each element. This unique name can be used to identify precisely the element that is the target of the conditional instruction. For example, if the instance document included the following structure:

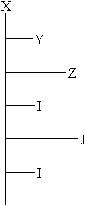

the element name X/I would refer to two elements and the graphical generator 155 would not know which element to render in response to an instruction to render the element named X/I. In other words, any conditional instruction involving element X/I could result in ambiguity including misplaced and incorrect data. By adding a unique identifier to the hierarchical name, a unique name can be produced for each element. For example, a unique identifier can be added to the previous structure to produce:

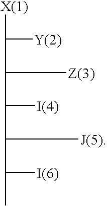

Element X(1)/I(4) can be now be distinguished from X(1)/I(6), thereby resolving any ambiguity.

Still referring to FIG. 3, after all of the relevant data, e.g., stylesheet data, instance data, and browser theme data, is collected, the graphical generator 155 can render the display for the user. Certain fields rendered by the graphical generator 155 may not be visible to the user. For example, the graphical generator 155 may include hidden text within any displayed page. This hidden text could indicate, for example, the original value for a field as indicated by the instance document. Hidden text is discussed in greater detail below.

Some, but not necessarily all, of the elements rendered by the graphical generator 155 may include user-editable fields. When such fields are edited, the corresponding data needs to be changed in the instance document. As previously described, the instance document is generally stored in a structured format, such as XML, and the data used by the GUI is generally stored in attribute-value pairs. Thus, the integration of the attribute- value pairs into the structured instance document is not readily achievable without manipulation of the data.

To achieve this integration, the post processor 160, in one embodiment, should determine where in the structured instance document that the edited attribute-value pairs should be placed. Assuming that the rendered attribute-value pairs are associated with a unique name, the post processor 160 can extract that name and identify the corresponding structure in the instance document. The value in the instance document at that corresponding structural location can then be changed to reflect the new value.

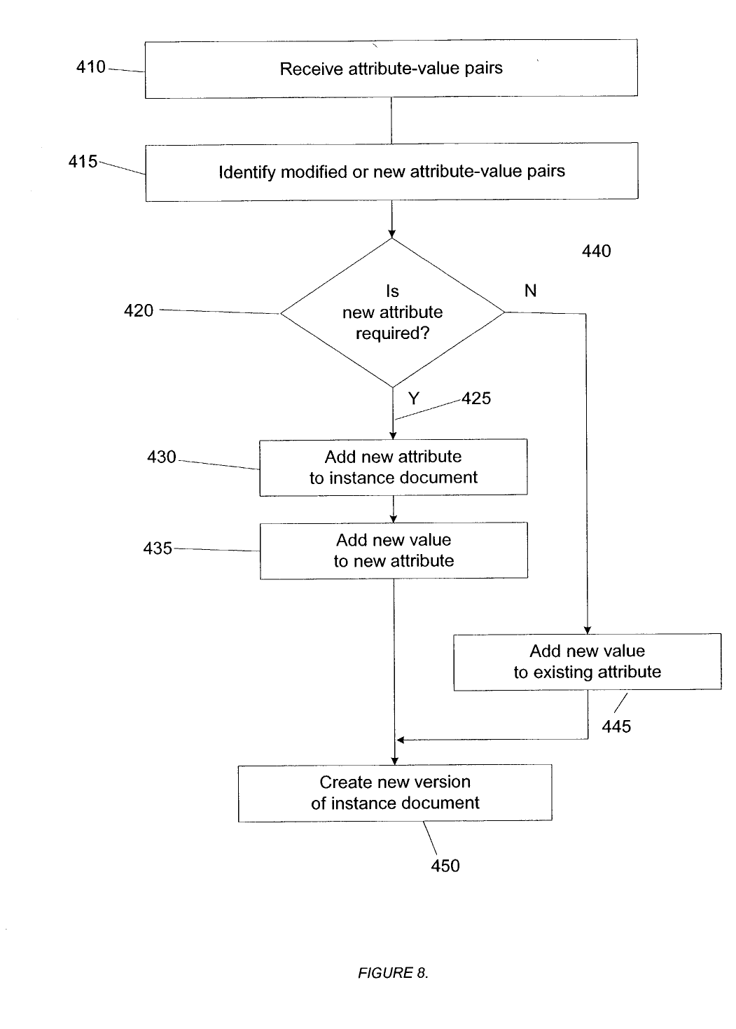

If the attribute-value pair does not correspond to structure already in the instance document, the post processor 160 uses the unique identifier and possibly an additional indicator to determine where to add new structure in the instance document. Once the post processor 160 identifies that location, the structure of the instance document can be changed to include the new element and the associated value. This process is discussed in greater detail with regard to FIG. 8. Finally, when all of the edited attribute-value pairs have been processed, the post processor 160 can strip the instance document of any added identifiers, and the instance document can be stored, for example, as a new version.

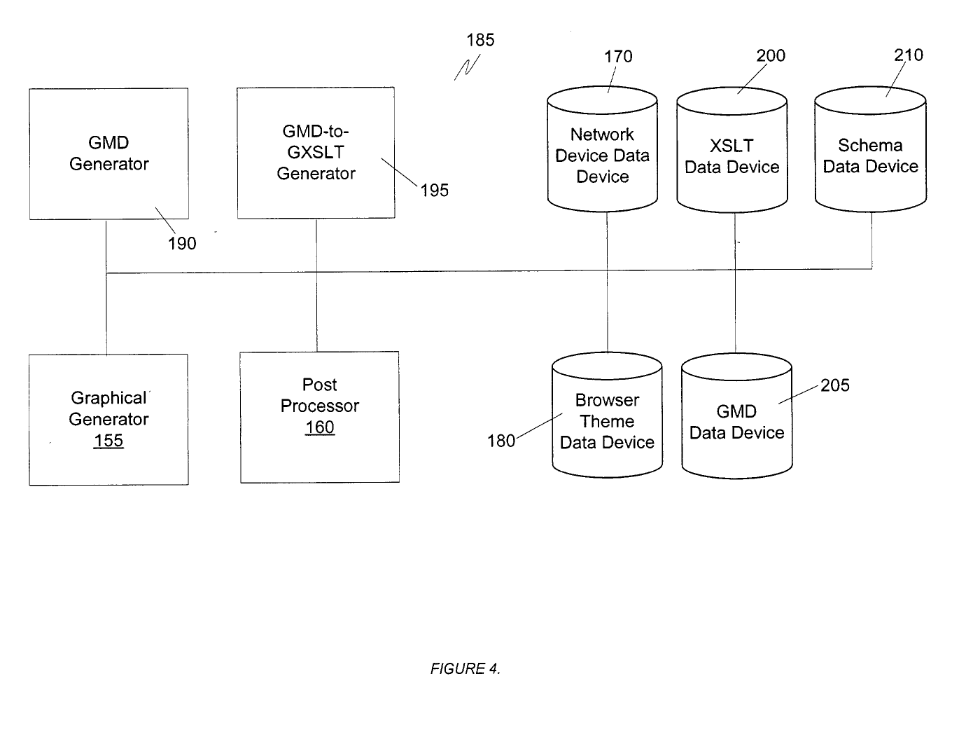

Referring now to FIG. 4, there is illustrated another embodiment 185 of the present invention. This embodiment includes a GMD generator 190, a GMD-to-GXSLT generator 195, a graphical generator 155, a post processor 160, a network device data device 170, a browser theme data device 180, an XSLT data device 200, a GMD data device 205, and schema data device 210. In operation, the GMD generator 190 reads schema data for each type of network device and generates a corresponding GMD document or series of GMD documents. Several GMD documents can be generated for a single class of network devices. Generally, these GMD documents can correspond to various configuration-categories. This process is discussed in more detail with regard to FIGS. 5 and 6.

The GMD-GXSLT generator 195 is configured to read the GMD data for each network device and to generate corresponding GXSLTs, which generally correspond to the stylesheets of FIG. 3. The process of generating the GSXLTs as well as the process for generating the GMDs can be performed at build time rather than at run time. Thus, the graphical generator 155 may only need the GSXLT data to generate the GUI. Notably, the GMD and the GXSLT contain similar data. The GMD, however, is generally declarative, and the GXSLT is generally procedural.

In this embodiment an XSL script is used to convert the GMD to GXSLT. This script converts the named parent oriented hierarchy of the GMD to a named child oriented hierarchy in the GXSLT. The data is also formatted for use by the browser-theme data.

Referring now to FIG. 5, there is illustrated a diagram of a system 215 for generating GMD files that are used by the GMD-GXSLT generator 195. Although the preferred embodiment involves converting a GMD file to a GXSLT file, other embodiments can convert the GMD file into other formats. In this embodiment, however, a GMD driver 220 is connected to a schema system 225 and to an output storage system 230. The schema system provides the input to the GMD driver 220 and generally includes a schema hash 235 and schema hash groupings 240 that correspond to the configuration categories. In other embodiments, the schema system 225 includes the full schema rather than an intermediate representation such as the schema hash.

As previously described, the schema is a structured representation of the configuration commands available to a particular router. A schema hash includes the information and structural relationships from the schema, but is arranged differently for efficiency reasons. For example, a schema hash can include a set of keys that corresponds to configuration commands. These keys can be used to access container objects that contain the associated schema data.

Referring again to the GMD driver 220, it retrieves schema data from the schema system 225 and uses that information to generate a GMD file 245 an output file 250. The operation of the GMD driver 220 and the other components is best described with relation to FIG. 6, which illustrates one method for generating a GMD.

In the method depicted by FIG. 6, schema data is initially retrieved for a particular class of network device (Step 260). The retrieved data can include raw schema data or schema hash data, which is comprised of command keys and associated container objects. When the schema hash is retrieved, both the command keys and the associated container objects can be retrieved. These command keys can then be grouped into configuration categories (Step 265).

A particular configuration category can then be selected and passed to the GMD driver 220 (Steps 270 and 275). A particular command from that grouping can then be selected and the appropriate schema material retrieved (Steps 280 and 285). That schema material can then be parsed to determine what type of objects should be displayed by the GUI to best represent the data (Step 290). For example, variable information in the retrieved schema material can be categorized into displayable objects such as text boxes, select buttons, radio buttons, Boolean boxes, roll-up objects, labels, etc.

Once the objects related to the selected command have been identified, these objects are output to a GMD file related to the current configuration category. Additionally, information related to the command can be output to a separate output file (Steps 300-320). This type of information can include the processed command's public name, its structural location within the schema, pointers to GMD files associated with parent commands, and pointers to GMD files associated with child commands.

After the GMD file and the output file are created for the selected command, a determination can be made as to whether any more commands exist within this configuration category (Step 325). If yes, branch Y (Step 330) is followed, a new command is selected, and the generation process is repeated.

If no other commands exist within this configuration category, branch N (Step 335) is followed and then a determination is made as to whether any more command categories for this class of device need to be processed (Step 340). If other configuration categories need to be processed, then branch Y (Step 345) is followed, a new configuration category is selected, and the process is repeated. If no other configuration categories exist, branch N (Step 350) is followed and the GMD files and output files generated for each command category are grouped and finalized as the GMD for the particular class of network device (Step 355). Notably, the above-described process can be completed for each class of network device, thereby creating a library of GMD files.

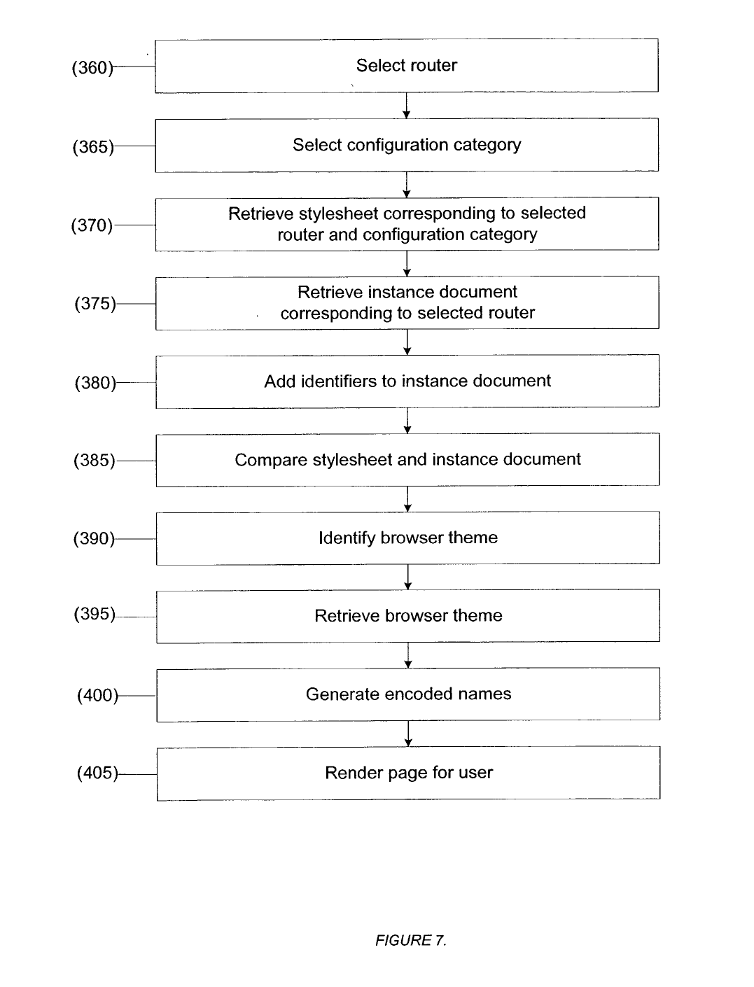

Referring now to FIG. 7, it is a flowchart of one method for displaying network device data. Although the present invention can work with any type of network device, the following example is directed at routers. In this embodiment, an end user initially selects a particular router or even a class of routers for configuration and/or viewing (Step 360). The user can then identify a particular configuration category that is of interest (Step 365). For example, the user could select “routing algorithms.”

After the device and configuration category have been selected, a corresponding stylesheet and instance document can be retrieved (Steps 370 and 375). The instance document, or at least a representation thereof, can be modified so that the elements contained therein are associated with a unique identifier (Step 380). The elements within the instance document can then be named, for example, according to a concatenation of their structural location, e.g., command path, and the unique identifier.

Using a series of conditional instructions, the retrieved stylesheet, or a script generated therefrom, can be executed against the instance document so that the elements in the stylesheet that should be rendered can be identified (Step 385). These identified elements can be rendered first by comparing them with the appropriate browser theme (Steps 390 and 395), which includes the actual rendering instructions, and second by populating those elements with data from the instance document. As each element is rendered, it is associated with the previously generated name (Step 400). These names can be represented, for example, as hidden text in an HTML document. Additionally, value data associated with each name can also be represented as hidden text. This value information can be used to determine if the user changed a field in a displayed page. Finally, the page can be displayed for the user (Step 405).

Referring now to FIG. 8, it is a flowchart of one method for extracting attribute-value pairs from a displayed page and inserting the corresponding data into a structured document. In this embodiment, the data corresponding to a particular network device and particular configuration-category has been rendered for the user and the user has made some change to the presented data. Once the user has made the changes, the user may submit or finalize those changes, thereby initiating a process for moving the changed data to the network device's instance document.

Because the data in the displayed page is generally represented by attribute-value pairs, the data generally should be transformed before it can be placed in the structured instance document. To transform the data, one embodiment of the present invention initially generates a list of attribute-value pairs within the page being submitted by the user (Step 410). This list can include the unique names assigned to each of the displayed attribute-value pairs.

Next, the attribute-value pairs within the displayed page that have been modified are identified (Step 415). These modified pairs can be identified based upon a comparison between the present value, e.g., the value on the submitted page, and the value included in the hidden text. Alternatively, they can be identified based upon a comparison between the present value and the value in the instance document. In either case, however, once the modified attribute-value pairs have been identified, the location within the instance document corresponding to the attribute portion of the attribute-value pairs is determined. This location can be determined, for example, by matching the name in the hidden text associated with an attribute-value pair to the corresponding command path in the instance document.

If it is determined that the instance document does not contain structure corresponding to one of the identified attribute-value pairs (Step 420), then branch Y (Step 425) is followed and new structure can be added to the instance document (Step 430). For example if the instance document is represented by:

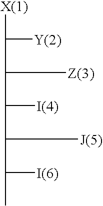

and the name associated with he new attribute-value pair element is X(1)/Y(2)/A, then a new structure and corresponding value could be added to the original structure (Step 435). The resulting structure would be:

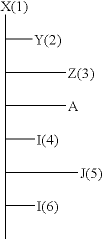

Assuming that the structure corresponding to the modified attribute-value pair already exists within the instance document, branch N (Step 440) is followed and the existing value for the identified attribute can be changed within the instance document without otherwise changing the structure of the instance document (Step 445).

Once the instance document has been modified to reflect the modified attribute- value pairs, the existing instance document can be overwritten or a new version of the instance document can be created (Step 450). By creating a new version rather than overwriting the old version, change control can be established. If the new version fails, the old version can be retrieved. Additionally, change-data such as editing-user and time-of-edit can be stored so that changes can be better tracked. In one embodiment, before a new version is saved, any added identifiers are stripped from the instance document.

In conclusion, the present invention provides, among other things, a system and method for graphically representing and managing network and network device information. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

We claim:

1. A method for generating a graphical display representing at least a partial configuration of a network device, the method comprising:
receiving an indication of a configuration category;
retrieving a stylesheet corresponding to the network device and to the configuration category;
retrieving instance data corresponding to the network device;
identifying a plurality of renderable objects using the retrieved stylesheet and the retrieved instance data;
retrieving a browser theme;
providing at least indications of the plurality of renderable objects to the browser theme; and
initiating rendering of the plurality of renderable objects.

2. The method of claim 1, wherein retrieving the stylesheet comprises:
retrieving an XSL script.

3. The method of claim 1, wherein the network device is associated with a class of network devices and wherein retrieving the stylesheet comprises:
retrieving the stylesheet corresponding to the class of network devices.

4. The method of claim 1, wherein identifying the plurality of renderable objects comprises:
executing at least an indication of the stylesheet against the retrieved instance data.

5. The method of claim 1, wherein retrieving instance data comprises:
retrieving an XML configuration document from a central repository, wherein the XML configuration document indicates at least a portion of the configuration of the network device.

6. The method of claim 1, wherein retrieving instance data comprises:
retrieving a structured document that indicates at least a portion of the configuration of the network device.

7. The method of claim 1, wherein retrieving the stylesheet comprises:
retrieving a plurality of conditional instructions.

8. The method of claim 7, wherein identifying a plurality of renderable objects comprises:
executing the plurality of conditional instructions against at least a portion of the instance data.

9. The method of claim 1, further comprising:
generating a plurality of unique names corresponding to at least a portion of the plurality of renderable objects.

10. The method of claim 9, further comprising:
rendering the renderable objects in conjunction with the unique names.

11. The method of claim 9, further comprising:
generating a unique identifier for at least each of the plurality of renderable objects.

12. The method of claim 11, wherein each of the plurality of renderable objects is associated with a hierarchical location and wherein generating the plurality of unique names comprises:
concatenating at least an indication of the hierarchical location for a first of the plurality of renderable objects and the object identifier for the first of the plurality of renderable objects.

13. A system comprising:
a graphical generator;
a stylesheet data device in communication with the graphical generator;
a network data device in communication with the graphical generator; and
a browser theme data device in communication with the graphical generator.

14. The system of claim 13, wherein the stylesheet data device comprises:
a plurality of XSLT documents.

15. The system of claim 13, wherein the stylesheet data device comprises:
a plurality of procedural documents.

16. The system of claim 13, wherein the stylesheet data device comprises:
a plurality of stylesheets, wherein each of the plurality of stylesheets corresponds to a particular class of network devices.

17. The system of claim 16, wherein the plurality of stylesheets are derived from a configuration schema, wherein the configuration schema corresponds to the particular class of network devices.

18. The system of claim 16, wherein the plurality of stylesheets are derived from a configuration GUI metadata, wherein the configuration GUI metadata corresponds to the particular class of network devices.

19. The system of claim 13, wherein the browser-theme data device comprises:
a plurality of rendering instructions for rendering data stored in the network data device.

20. The system of claim 13, further comprising:
a stylesheet generator configured to generate stylesheets to be stored on the stylesheet data device.

21. The system of claim 20, wherein the stylesheet generator comprises:
an XSLT generator.

22. The system of claim 21, wherein the XSLT generator comprises:
a GMD-to-GXSLT generator.

23. The system of claim 20, further comprising:
a schema data device configured to store configuration schema data;
wherein the configuration schema data is usable by the stylesheet generator to generate the stylesheets.

24. The system of claim 20, further comprising:
a schema data device configured to store configuration schema data; and
a GMD generator for generating GUI metadata from the configuration schema data;
wherein the GUI metadata is usable by the stylesheet generator to generate the stylesheets.

25. A system for generating a graphical display representing at least a partial configuration of a network device, the system comprising:
a processor;
a storage device connected to the processing device; and
a plurality of instructions stored on the storage device, the plurality of instructions configured to cause the processor to:
retrieve a stylesheet corresponding to the network device and to a configuration category;
retrieve instance data corresponding to the network device;
identify a plurality of renderable objects using the retrieved stylesheet and the retrieved instance data;
retrieve a browser theme;
provide at least indications of the plurality of renderable objects to the browser theme; and
initiate rendering of the plurality of renderable objects.

26. The system of claim 25, wherein the network device is associated with a class of network devices and wherein the plurality of instructions are configured to cause the processor to retrieve the stylesheet by at least:
retrieving the stylesheet corresponding to the class of network devices.

27. The system of claim 25, wherein the plurality of instructions are configured to cause the processor to retrieve instance data by at least:
retrieving a structured document that indicates at least a portion of the configuration of the network device.

28. The system of claim 25, wherein the plurality of instructions are further configured to cause the processor to:
generate a plurality of unique names corresponding to at least a portion of the plurality of renderable objects.

29. The system of claim 28, wherein the plurality of instructions are further configured to cause the processor to:
render the renderable objects in conjunction with the unique names.

30. The system of claim 28, wherein the plurality of instructions are further configured to cause the processor to:
generate a unique identifier for at least each of the plurality of renderable objects.

31. The system of claim 30, wherein each of the plurality of renderable objects is associated with a hierarchical location and wherein the plurality of instructions are configured to cause the processor to generate the plurality of unique names by at least:
concatenating at least an indication of the hierarchical location for a first of the plurality of renderable objects and the object identifier for the first of the plurality of renderable objects.

32. A method for generating a graphical display representing configuration data of a network device, the method comprising:
identifying procedural instructions corresponding to a configuration element in the configuration data;
identifying rendering instructions corresponding to the retrieved procedural instructions; and
rendering an indication of the configuration element according to the rendering instructions.

33. The method of claim 32, wherein identifying procedural instructions comprises:
retrieving stylesheet data corresponding to a particular class of network devices.

34. The method of claim 32, wherein identifying rendering instructions comprises:
retrieving browser theme data.

35. The method of claim 32, wherein the configuration element is included in a structured configuration document.

36. The method of claim 32, wherein the configuration element is included in an XML configuration document.

37. The method of claim 32, wherein identifying procedural instructions comprises:
identifying a plurality of conditional instructions.

38. The method of claim 37, wherein identifying rendering instructions comprises:
executing at least a portion of the plurality of conditional instructions against the configuration element.

39. The method of claim 32, further comprising:
generating a unique name for the configuration element.

40. The method of claim 39, wherein rendering an indication of the configuration element comprises:
rendering the unique name as hidden text.

41. A system for generating a graphical display representing configuration data of a network device, the system comprising:
means for identifying procedural instructions corresponding to a configuration element in the configuration data;
means for identifying rendering instructions corresponding to the retrieved procedural instructions; and
means for rendering an indication of the configuration element according to the rendering instructions.

42. The system of claim 41, wherein the means for identifying procedural instructions comprises:
means for identifying a plurality of conditional instructions.

43. The system of claim 42, wherein the means for identifying rendering instructions comprises:
means for executing at least a portion of the plurality of conditional instructions against the configuration element.

44. The system of claim 41, further comprising:
means for generating a unique name for the configuration element.

45. The system of claim 44, wherein the means for rendering an indication of the configuration element comprises:
means for rendering the unique name as hidden text.

46. A system for generating a graphical display representing configuration data of a network device, the system comprising:
a processor;
a memory device; and
a plurality of instructions stored on the memory device, the plurality of instructions configured to cause the processor to:
identify procedural instructions corresponding to a configuration element in the configuration data;
identify rendering instructions corresponding to the retrieved procedural instructions; and
render an indication of the configuration element according to the rendering instructions.
